(19) United States
(12) Patent Application Publication
(10) Pub. No.: US 2015/0371388 A1
(43) Pub. Date: Dec. 24, 2015

(54) INFORMATION PROCESSING DEVICE, COMPUTER-READABLE RECORDING MEDIUM, AND INFORMATION PROCESSING METHOD

(71) Applicants: Shogo ISHIDA, Kanagawa (JP); Shiroh Ikegami, Tokyo (JP); Atsuo Kawaguchi, Kanagawa (JP)

(72) Inventors: Shogo ISHIDA, Kanagawa (JP); Shiroh Ikegami, Tokyo (JP); Atsuo Kawaguchi, Kanagawa (JP)

(21) Appl. No.: 14/731,716

(22) Filed: Jun. 5, 2015

(30) Foreign Application Priority Data
Jun. 18, 2014 (JP) 2014-125656

(51) Int. Cl. G06T 7/00; G06T 17/20; G06T 15/04; G06T 7/40

(52) U.S. Cl. CPC G06T 7/0032; G06T 7/408; G06T 17/20; G06T 15/04; G06T 2207/10024; G06T 2207/10028; G06T 2207/20182; G06T 2200/04

(57) ABSTRACT

An information processing device includes a range image acquisition unit that acquires at least two range images of an observation object, a color image acquisition unit that acquires color images of the observation object, which respectively correspond to the range images, a feature portion detection unit that detects feature portions from the acquired color images, a calibration unit that performs calibration processing that associates each pixel of the color image with each point of the range image, which corresponds to each pixel, and generates calibration information that indicates each point corresponding to each pixel, and an alignment processing unit that performs alignment of the range images so that the detected feature portions overlap with each other by using the detected feature portions and the calibration information.

### CROSS-REFERENCE TO RELATED APPLICATIONS

The present application claims priority to and incorporates by reference the entire contents of Japanese Patent Application No. 2014-125656 filed in Japan on Jun. 18, 2014.

### BACKGROUND OF THE INVENTION

1. Field of the Invention

The present invention relates to an information processing device, a computer-readable recording medium, and an information processing method.

2. Description of the Related Art

A technique is known which obtains a three-dimensional model of an entire observation object from a range image of the observation object acquired by a range sensor. Range information included in the range image is range information measured from a single direction. Therefore, when obtaining a three-dimensional model of the entire observation object, images of the observation object are captured from a plurality of different directions and range information corresponding to each image capturing direction is acquired. In general, local feature amounts of respective range images are defined, portions of range images that have a similar feature amount are associated with each other, and relative alignment of the range images acquired from a plurality of directions is performed, so that the three-dimensional model of the entire observation object is generated.

JP 5253066 B1 discloses a position and posture measurement device that stabilizes and streamlines position and posture detection processing by appropriately selecting features used to calculate position and posture from among features extracted from three-dimensional model data of an observation object body.

In the case of this position and posture measurement device, a plurality of geometric features based on geometric information of the observation object body are extracted by drawing the three-dimensional model data which represents a surface shape of the observation object body. Further, a reference image where the position and the posture of an image capturing device with respect to the observation object body have been calculated is searched for image features corresponding to the plurality of geometric features, and geometric features of which corresponding image feature is detected are selected from the plurality of extracted geometric features. Then, the position and the posture of the image capturing device with respect to the observation object body are calculated by associating the selected geometric features with an image of the observation object body in an input image.

Thereby, even when the features extracted from the three-dimensional model data of the observation object body are largely different from features that can be extracted from the observation object body of which image is captured in a captured image, it is possible to stably estimate the position and the posture.

However, there is a problem that a conventional alignment method is difficult to estimate a corresponding point when the amount of overlapping portions between range images is small and when there is no characteristic portion in a three-dimensional structure.

Further, in the case of the position and posture measurement device disclosed in JP 5253066 B1, a plurality of geometric features based on geometric information of the observation object body are extracted by drawing the three-dimensional model data which represents a surface shape of the observation object body. Therefore, there is a problem that it is very difficult to align an unknown object for which no three-dimensional model is prepared in advance.

Therefore, there is a need for an information processing device, a computer-readable recording medium, and an information processing method, which can accurately align a plurality of range images.

### SUMMARY OF THE INVENTION

It is an object of the present invention to at least partially solve the problems in the conventional technology.

There is provided an information processing device that includes a range image acquisition unit that acquires at least two range images of an observation object, a color image acquisition unit that acquires color images of the observation object, which respectively correspond to the range images, a feature portion detection unit that detects feature portions from the acquired color images, a calibration unit that performs calibration processing that associates each pixel of the color image with each point of the range image, which corresponds to each pixel, and generates calibration information that indicates each point corresponding to each pixel, and an alignment processing unit that performs alignment of the range images so that the detected feature portions overlap with each other by using the detected feature portions and the calibration information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a hardware configuration diagram of an image processing device of a first embodiment;

FIG. 2 is a functional block diagram of the image processing device of the first embodiment;

FIG. 3 is a functional block diagram of a posture calculation unit provided in the image processing device of the first embodiment;

FIG. 4 is a flowchart illustrating a flow of alignment processing of the image processing device of the first embodiment;

FIG. 5A and FIG. 5B are diagrams for explaining a specific example of the alignment processing of the image processing device of the first embodiment;

FIG. 6A and FIG. 6B are diagrams for explaining another specific example of the alignment processing of the image processing device of the first embodiment;

FIG. 7 is a functional block diagram of an image processing device of a second embodiment;

FIG. 8 is a flowchart illustrating a flow of alignment processing of an image processing device of a third embodiment;

FIG. 9 is a functional block diagram of an image processing device of a fourth embodiment;

FIG. 10 is a functional block diagram of a feature portion detection unit provided in the image processing device of the fourth embodiment;

FIG. 11 is a flowchart illustrating a flow of a learning operation of a feature model in the feature portion detection unit of the image processing device of the fourth embodiment;

FIG. 12A and FIG. 12B are diagrams for explaining labeling processing in a likelihood calculation unit of the image processing device of the fourth embodiment;

FIG. 13 is a flowchart for explaining an operation of the likelihood calculation unit of the image processing device of the fourth embodiment;

FIG. 14 is a flowchart illustrating a flow of alignment processing of an alignment processing unit of the image processing device of the fourth embodiment;

FIG. 15 is a diagram for explaining a problem that point groups of respective range images do not overlap with each other, which may occur when alignment is performed on the premise that end points of point groups are coincident with each other; and

FIG. 16 is a diagram illustrating a state in which point groups of respective range images are accurately overlapped with each other by performing alignment by using feature portions in the image processing device of the fourth embodiment.

### DETAILED DESCRIPTION OF THE PREFERRED EMBODIMENTS

Hereinafter, as an example, an image processing device, which is an embodiment to which an information processing device, an information processing program, and an information processing system are applied, will be described in detail with reference to the attached drawings.

### First Embodiment

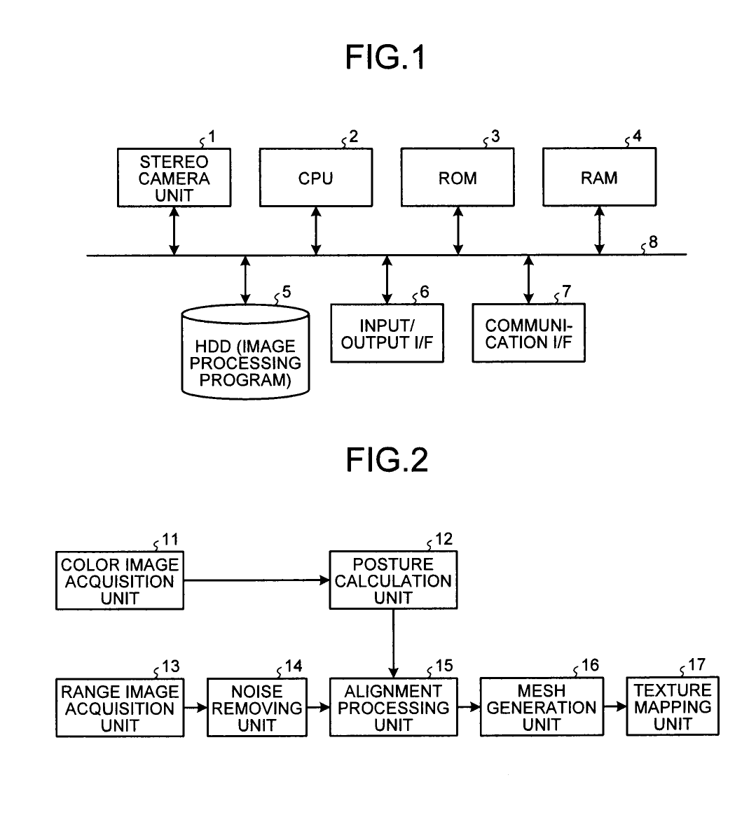

First, FIG. 1 illustrates a hardware configuration diagram of an image processing device of a first embodiment. As illustrated in FIG. 1, the image processing device of the embodiment includes a stereo camera unit 1, a CPU 2, a ROM 3, a RAM 4, an HDD 5, an input/output I/F 6, and a communication I/F 7. The components 1 to 7 are connected with each other through a bus line 8. The CPU is an abbreviation of “Central Processing Unit”. The ROM is an abbreviation of “Read Only Memory”. The RAM is an abbreviation of “Random Access Memory”. The HDD is an abbreviation of “Hard Disk Drive”. The I/F is an abbreviation of “Interface”.

The stereo camera unit 1 is configured by two camera units including a first camera unit for left eye and a second camera unit for right eye, which are incorporated in parallel with each other. Each camera unit includes a lens, an image sensor, and a sensor controller. The image sensor is, for example, a CCD image sensor or a CMOS image sensor. The CCD is an abbreviation of “Charge Coupled Device”. The CMOS is an abbreviation of “Complementary Metal-Oxide Semiconductor”. The sensor controller performs exposure control of the image sensor, image read control, communication with an external circuit, transmission control of image data, and the like.

The HDD 5 (or ROM 3 or RAM 4) stores an image processing program which is an example of the information processing program. The image processing program includes an alignment processing program for performing alignment processing of range images obtained by capturing images of an observation object from different directions by the stereo camera unit 1. Further, the image processing program includes a mesh generation processing program that converts each aligned range image into a mesh and generates a three-dimensional model. Further, the image processing program includes a texture mapping processing program that maps a predetermined texture on the three-dimensional model generated by the mesh generation processing program.

Luminance image data of a captured image that is captured by each camera unit of the stereo camera unit 1 is written to the RAM 4 through the bus line 8. The CPU 2 generates a parallax image (range image) by performing, for example, a gamma correction, a skew correction (paralleling the left and right images with each other), and parallax calculation by block matching, which are processing requiring real-time property, on the luminance image data stored in the RAM 4, and writes the parallax image to the RAM 4 again. Further, the CPU 2 controls an operation of an entire drawing processing device and further performs and controls alignment processing, mesh generation processing, texture mapping processing, and the like of each range image written to the RAM 4 according to a drawing processing program stored in the ROM 3.

Next, to create a three-dimensional model of an observation object, it is necessary to overlap range images captured from different directions. To overlap the range images, it is necessary that relative positional relationship between the range images is known. Processing to derive the relative positional relationship is the alignment processing. For the alignment processing, the image processing device of the embodiment acquires a color image and a range image from the same direction and calculates an image capturing direction of the observation object by using the acquired color image. Then, the image processing device of the embodiment performs alignment of each range image by using a calculated orientation of the object. Thereby, even when a portion where the range images overlap with each other is small, or even when there is no geometric feature, it is possible to perform the alignment by using a relative direction between the range images obtained from posture estimation.

FIG. 2 illustrates a functional block diagram of functions implemented by the CPU 2 executing an image processing program. As illustrated in FIG. 2, the CPU 2 functions as a color image acquisition unit 11, a posture calculation unit 12, a range image acquisition unit 13, a noise removing unit 14, an alignment processing unit 15, a mesh generation unit 16, and a texture mapping unit 17. In this example, the color image acquisition unit 11 to the texture mapping unit 17 will be described assuming that these units are implemented by software. However, some or all of these units may be implemented by hardware.

The color image acquisition unit 11 acquires a color image (RGB image) of the observation object. The range image acquisition unit 13 acquires a range image of the observation object. Regarding the color image acquired by the color image acquisition unit 11 and the range image acquired by the range image acquisition unit 13, the color image and the range image which are acquired from the same direction are linked (associated) with each other and stored in the RAM 4. The posture calculation unit 12 calculates an image capturing direction of the observation object by using the color image acquired by the color image acquisition unit 11.

The noise removing unit 14 removes noise such as high-frequency noise from the range image acquired by the range image acquisition unit 13. The alignment processing unit 15 performs alignment of the range image from the posture (the orientation of the observation object) calculated by the posture calculation unit 12. The mesh generation unit 16 converts each aligned range image into a mesh to generate a three-dimensional model. The texture mapping unit 17 maps a predetermined texture on the three-dimensional model generated by the mesh generation processing.

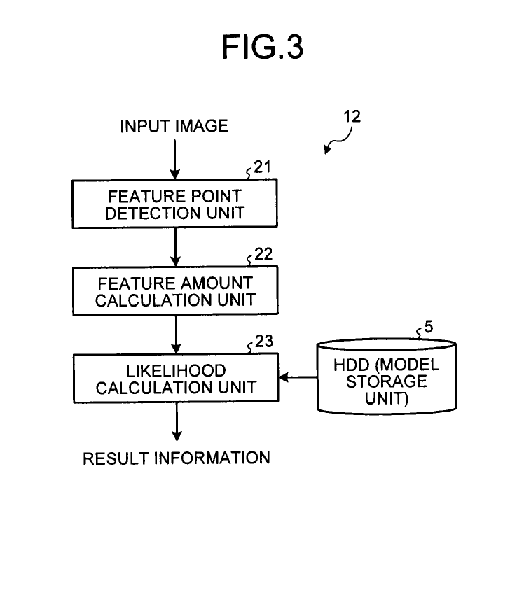

When the CPU 2 functions as the posture calculation unit 12, the CPU 2 functions as a feature point detection unit 21, a feature amount calculation unit 22, and a likelihood calculation unit 23 as illustrated in FIG. 3. The feature point detection unit 21 calculates a feature point of an inputted color image. The feature amount calculation unit 22 calculates a feature amount of the feature point obtained by the feature point detection unit 21. The HDD 5 illustrated in FIG. 3 functions as a model storage unit. The HDD 5 stores a model in which positions and feature amounts of feature points are described for images acquired from various directions. For example, in the case of a model of a vehicle, images of the vehicle are captured from various directions, and positions and feature amounts of feature points for each captured image are calculated in advance and stored in the HDD 5 in association with each captured image. The likelihood calculation unit 23 calculates likelihood for positions and feature amounts of feature points obtained from an inputted color image by using the model stored in the HDD 5 and supplies the calculation result (result information) to the alignment processing unit 15.

In summary, the posture calculation unit 12 detects feature points of an inputted color image, calculates a feature amount at each feature point, and defines a positional relationship between the feature points and the feature amounts as an original property. Then, the posture calculation unit 12 calculates the image capturing direction of the observation object corresponding to the inputted color image by calculating an orientation (posture) where the likelihood is greatest for the original property obtained from the inputted color image by using a learning model.

How to calculate the orientation (posture) of the object is disclosed in detail in S. Savarese and L. Fei-Fei, “3D generic object categorization, localization and pose estimation”, IEEE Intern. Conf. in Computer Vision (ICCV), Brazil, October, 2007.

A method for calculating an orientation of a vehicle at a degree of accuracy of about 90% by creating a learning model by 80 images of the vehicle captured from eight directions is disclosed in Nadia Payet, Sinisa Todorovic, “From contours to 3D object detection and pose estimation”, ICCV 2011: 983-990.

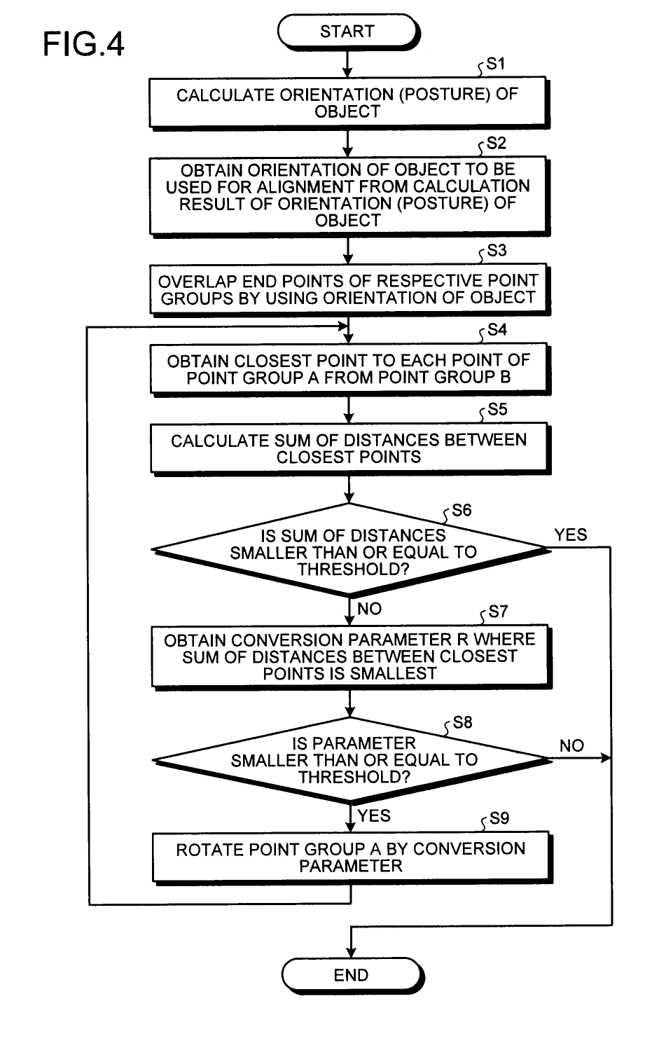

Next, the flowchart in FIG. 4 illustrates a flow of an alignment operation of the alignment processing unit 15. In the case of the image processing device of the embodiment, as an example, an alignment method called ICP is used. The ICP is an abbreviation of “Iterative Closest Point”. For the detailed operation of the ICP, refer to Besl, Paul J.; N. D. McKay (1992). “A Method for Registration of 3-D Shapes”. IEEE Trans. on Pattern Analysis and Machine Intelligence (Los Alamitos, Calif., USA: IEEE Computer Society) 14 (2): 239-256.

The range image is an image in which distance information to the observation object is stored in each pixel. It is possible to generate point group data by mapping range image data on an xyz coordinate system. In the ICP, alignment of each range image is performed by minimizing the sum of the distances between the point groups in the processing illustrated in the flowchart of FIG. 4. For example, when performing alignment of a first range image (point group A) and a second range image (point group B) by the ICP, the alignment processing unit 15 arranges the point group A and the point group B on the same coordinate system. Then, the alignment processing unit 15 performs the alignment of the first range image and the second range image so that the sum of the distances between closest points of the point group A and the point group B is smallest. When arranging the point group A and the point group B on the same coordinate system, the alignment processing unit 15 arranges the point group A and the point group B so that the center point of the point group A and the center point of the point group B are located at the same position and performs alignment of the range images by rotating the point groups so that the orientations of the point groups are coincident with the orientation (direction) of the object calculated by the posture calculation unit 12.

Specifically, in step S1 in the flowchart of FIG. 4, the posture calculation unit 12 calculates the orientation (posture) of the observation object by using color images (color images respectively corresponding to the first and the second range images to be aligned) acquired by the color image acquisition unit 11. In step S2, the alignment processing unit 15 recognizes the orientations of the range images of the observation object to be aligned from the calculation result of the orientation (posture) of the observation object calculated by the posture calculation unit 12.

Next, in step S3, the alignment processing unit 15 overlaps end points of respective point groups of the first range image and the second range image based on the recognized orientations of the range images. For example, it is assumed that when the posture calculation unit 12 calculates the orientation (posture) of the observation object from the color image corresponding to the first range image and the color image corresponding to the second range image, it is calculated that the first range image is a range image obtained by capturing an image of the observation object from the front direction and the second range image is a range image obtained by capturing an image of the observation object from the right direction. The most front right point in the point group of the first range image obtained by capturing an image of the observation object from the front direction and the most front left point in the point group of the second range image obtained by capturing an image of the observation object from the right direction are substantially coincident with each other. In step S3, the alignment processing unit 15 performs processing to overlap end points of point groups of range images which can be overlapped with each other in this manner.

Next, in step S4, the alignment processing unit 15 detects the closest point to each point of the point group A of the first range image from the point group B of the second range image. Further, in step S5, the alignment processing unit 15 calculates the sum of the distances between closest points of the first range image and the second range image. In step S6, the alignment processing unit 15 compares the sum of the distances between closest points of the first range image and the second range image with a predetermined threshold. Then, in step S6, the alignment processing unit 15 determines whether or not the sum of the distances between closest points of the first range image and the second range image is smaller than or equal to the predetermined threshold. The fact that the sum of the distances between closest points is smaller than or equal to the predetermined threshold (step S6: Yes) means that the first range image and the second range image roughly overlap with each other at a position corresponding to each image capturing direction (the alignment is completed). Therefore, the alignment processing unit 15 ends the processing of the flowchart in FIG. 4.

On the other hand, the fact that the sum of the distances between closest points is greater than the predetermined threshold (step S6: No) means that the first range image and the second range image do not overlap with each other at a position corresponding to each image capturing direction. Therefore, the alignment processing unit 15 proceeds to step S7 and calculates a conversion parameter R where the sum of the distances between closest points is smallest. The conversion parameter R is a parameter indicating a rotation angle of the first range image or the second range image. For example, when alignment of the first range image obtained by capturing an image of the observation object from the front direction and the second range image obtained by capturing an image of the observation object from the right direction is performed, the conversion parameter R does not represent a rotation of 90 degrees or more. This is because when a rotation of 90 degrees or more is performed, the calculation result of the orientation (posture) of the observation object, which is the front direction and the right direction, in the posture calculation unit 12 is an error.

Therefore, in step S8, the alignment processing unit 15 determines whether or not the calculated conversion parameter R is smaller than or equal to a predetermined threshold (90 degrees). The fact that the calculated conversion parameter R is greater than the predetermined threshold (90 degrees) (step S8: No) means that the calculated conversion parameter R is an error as described above, so that the alignment processing unit 15 ends the processing of the flowchart in FIG. 4 as an “error”.

On the other hand, the fact that the calculated conversion parameter R is smaller than or equal to the predetermined threshold (90 degrees) (step S8: Yes) means that the calculated conversion parameter R is a conversion parameter R that can cause the first range image and the second range image to be close to each other so that the first range image and the second range image can be roughly overlapped with each other at a position corresponding to each image capturing direction. Therefore, in step S9, the alignment processing unit 15 rotates the point group A of the first range image by the calculated conversion parameter R and returns to step S4.

Thereafter, the alignment processing unit 15 repeatedly performs the step S4 to step S9 to perform alignment of the first range image with respect to the second range image while gradually rotating the point group A of the first range image by the conversion parameter R calculated each time. Then, in step S6, when the alignment processing unit 15 determines that the sum of the distances between closest points is smaller than or equal to the predetermined threshold (step S6: Yes), it means that the first range image and the second range image roughly overlap with each other at a position corresponding to each image capturing direction (the alignment is completed). Therefore, the alignment processing unit 15 ends the processing of the flowchart in FIG. 4. When the alignment processing unit 15 calculates the conversion parameter R, if the value of the calculated conversion parameter R exceeds the predetermined threshold (90 degrees), the alignment processing unit 15 determines that an “error” occurs and ends the flowchart of FIG. 4 as described above.

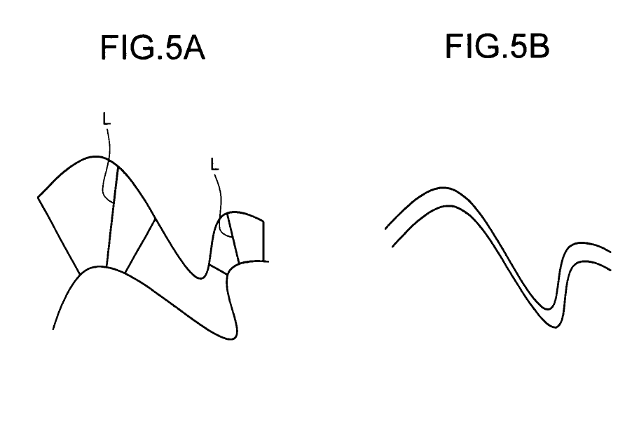

A specific example of such alignment processing will be described. For example, a case is considered in which the ICP is performed on point groups obtained by measuring curved surfaces. A diagram in FIG. 5A is a diagram in which a point included in a point group of one curved surface and a point included in a point group of another curved surface are selected so that a distance between the selected points is the closest, and the selected points are connected by a straight line L. The sum of the lengths of the straight lines L is the sum of the distances between closest points. The alignment processing unit 15 translates or rotates the point groups so that the sum of the distances is smallest. Thereby, it is possible to cause the point groups to be close to each other as illustrated in the diagram in FIG. 5B. The alignment processing unit 15 also performs alignment of the point groups illustrated in the diagram in FIG. 5B by selecting the closest points in the same manner as described above and repeatedly performing translation processing and rotation processing of the point groups.

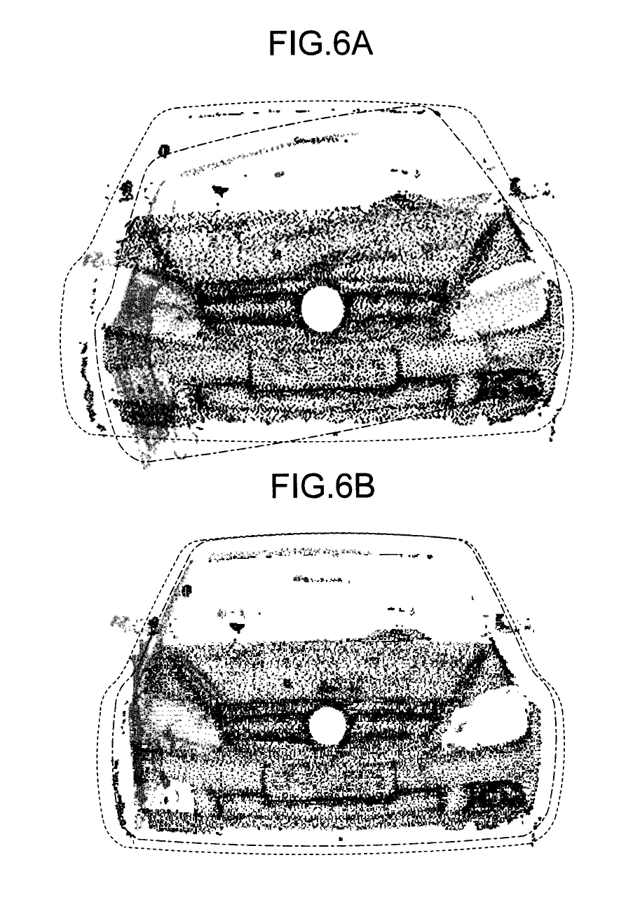

In the same manner, FIG. 6A and FIG. 6B are diagrams for explaining alignment of range images obtained by capturing images of a vehicle from the front. In the diagram in FIG. 6A, a diagram of a point group of which contour is surrounded by a dashed line indicates a first range image. On the other hand, in the diagram in FIG. 6A, a diagram of a point group of which contour is surrounded by a dashed-dotted line indicates a second range image. The second range image is an image rotated counterclockwise with respect to the first range image. The alignment processing unit 15 calculates a conversion parameter R that minimizes the sum of the distances between closest points and translates or rotates the point group of the second range image (or the first range image). Thereby, it is possible to perform alignment of the first range image and the second range image as illustrated in the diagram in FIG. 6B.

Next, the mesh generation unit 16 illustrated in FIG. 2 generates a three-dimensional model by converting the range images aligned in this way into a meth as one range image. Then, the texture mapping unit 17 attaches a corresponding texture to the generated three-dimensional model and outputs the three-dimensional model.

As obvious from the above description, when the image processing device of the first embodiment performs alignment of the first range image and the second range image, the image processing device acquires a color image captured from the same image capturing direction as that of the first range image. Further, the image processing device acquires a color image captured from the same image capturing direction as that of the second range image. The posture calculation unit 12 calculates the image capturing direction of each color image (=the image capturing direction of each range image) by referring to a learning model stored in the HDD 5. The alignment processing unit 15 calculates a conversion parameter R that causes the sum of the distances between closest points of the first range image and the second range image to be smaller than or equal to a predetermined threshold. Then, the alignment processing unit 15 performs alignment of the range images by translating or rotating the first range image (or the second range image) by using the calculated conversion parameter R.

Even when the amount of overlapping portions between the range images is small or there is no geometric feature point in the range images, it is possible to more accurately perform the alignment using a relative direction between the range images obtained from the posture estimation by calculating the image capturing direction of the observation object by using the acquired color image.

Further, the alignment processing unit 15 performs the alignment by using the range image from which noise is removed by the noise removing unit 14. When noise is superimposed on the range image, the alignment is performed by using the range image which is partially distorted, so that it is difficult to perform accurate alignment. However, the image processing device of the embodiment performs the alignment after removing noise of each range image by the noise removing unit 14. Therefore, it is possible to perform more accurate alignment.

The image processing device of the embodiment as described above can be applied to, for example, a three-dimensional scanner device and an eye of an industrial robot. A three-dimensional model is required to obtain an output of a three-dimensional printer. The three-dimensional scanner device can be used as a means to generate a three-dimensional model. When performing alignment by acquiring range images from various directions by the three-dimensional scanner device, if a portion where the range images overlap with each other is small, it is difficult to accurately perform the alignment. However, the image processing device of the embodiment can perform accurate alignment even when a portion where the range images overlap with each other is small, so that it is possible to improve convenience of the three-dimensional scanner device.

When the image processing device of the embodiment is applied to an industrial robot, not only a color image, but also range images are used to correctly recognize a component. To correctly recognize the component as a three-dimensional model, it is necessary to acquire range images from a plurality of directions, and it is necessary to acquire the range images from various directions so that there are some overlaps. In a production line or the like, components flowing on the production line are usually determined in advance, so that it is easy to create a learning model and the image processing device of the embodiment will effectively function.

In the above description of the embodiment, a range image generated by performing parallax calculation of each captured image of the stereo camera unit 1 is used. As the range image, it is possible to use image information to which distance information detected by radar ranging or the like for each point of an image is added.

It is all right that a range image and a corresponding color image are stored in a memory, the posture calculation unit 12 reads the color image from the memory and calculates the orientation of the range image, and the alignment processing unit 15 performs alignment of each range image read from the memory by using the calculated orientation of the range image.

### Second Embodiment

Next, an image processing device of a second embodiment will be described. The image processing device of the first embodiment converts an aligned range image into a meth. On the other hand, the image processing device of the second embodiment removes unnecessary points from an aligned range image and then converts the range image into a meth. The second embodiment described below is different from the first embodiment described above only in the point described above. Therefore, in the description below, only the difference between the first embodiment and the second embodiment will be described and redundant description will be omitted.

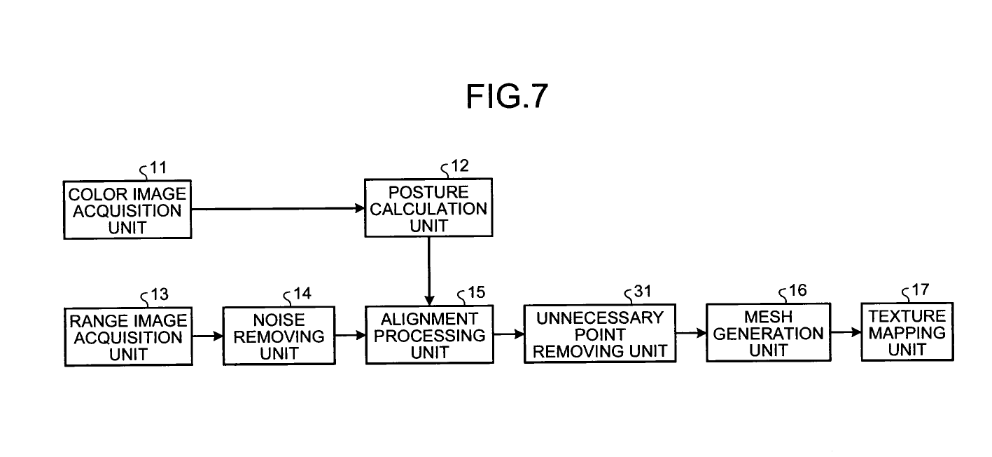

FIG. 7 is a functional block diagram of the image processing device of the second embodiment. As illustrated in FIG. 7, the image processing device of the second embodiment includes an unnecessary point removing unit 31 between the alignment processing unit 15 and the mesh generation unit 16. The unnecessary point removing unit 31 may be implemented by software or may be implemented by hardware.

The alignment processing unit 15 generates one range image by aligning, for example, two range images as described above. Therefore, the generated range image includes unnecessary points when seen as a point image. Therefore, the unnecessary point removing unit 31 forms a range image as an integrated point image by removing points which are unnecessary when two aligned range images are seen as a point image.

Thereby, the mesh generation unit 16 can perform mesh generation processing without being affected by the unnecessary points and it is possible to obtain the same advantageous effect as that of the first embodiment described above.

### Third Embodiment

Next, an image processing device of a third embodiment will be described. In the processing of step S8 in the flowchart illustrated in FIG. 4, when the value of the calculated conversion parameter R exceeds the predetermined threshold (90 degrees), the image processing device of the first embodiment described above handles this as an “error” and directly ends the processing of the flowchart in FIG. 4. On the other hand, when the value of the calculated conversion parameter R exceeds the predetermined threshold (90 degrees), the image processing device of the third embodiment recalculates the orientation of the range image and performs the alignment again. The third embodiment described blow is different from the first embodiment described above only in the point described above. Therefore, in the description below, only the difference between the first embodiment and the third embodiment will be described and redundant description will be omitted.

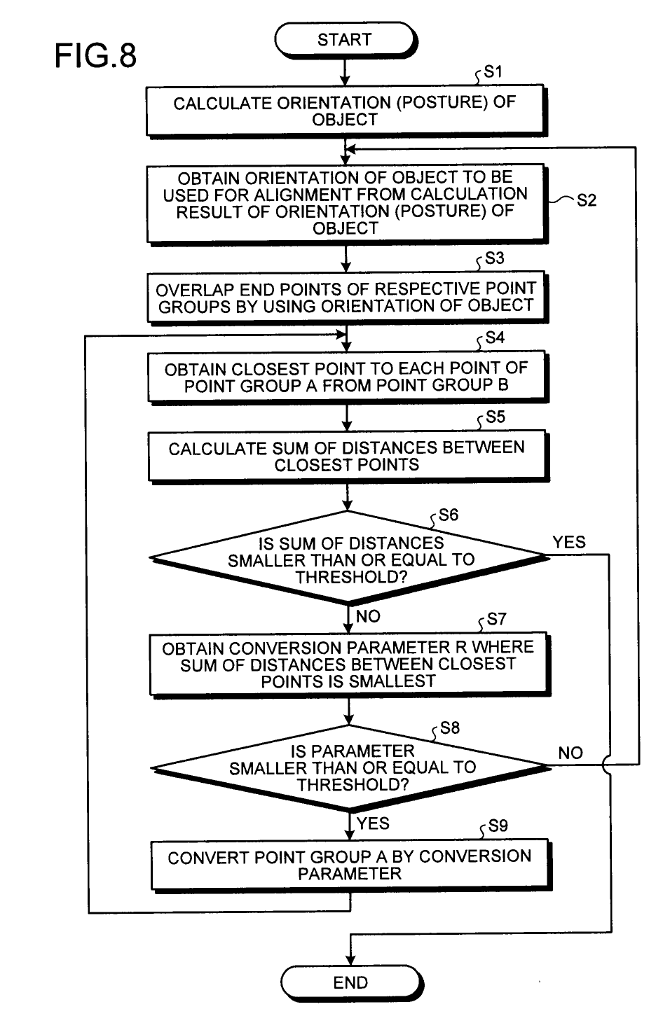

FIG. 8 is a flowchart illustrating a flow of alignment processing of the image processing device of the third embodiment. In the flowchart of FIG. 8, steps that indicate the same processing as that in the flowchart of FIG. 4 are denoted by the same step numbers as those in the flowchart of FIG. 4. As known from the flowchart in FIG. 8, in the case of the image processing device of the third embodiment, in step S8, when the alignment processing unit 15 determines that the value of the calculated conversion parameter exceeds the predetermined threshold (step S8: No), the alignment processing unit 15 returns to step S2 and recalculates the orientation (posture) of each range image again.

In other words, in the case of the image processing device of the third embodiment, the posture calculation unit 12 calculates the orientation of each range image based on the color image in step S1. In this case, the posture calculation unit 12 does not calculate only one piece of information representing the orientation of each image, but calculates a plurality of orientations with a quantitative scale such as, for example, the likelihood of x direction is 90 and the likelihood of y direction is 80.

The alignment processing unit 15 first calculates the orientation of each range image by using the direction of which likelihood is the highest (in this case, the x direction). However, when the value of the conversion parameter R exceeds the threshold in step S8, the alignment processing unit 15 calculates the orientation of each range image by using the direction of which likelihood is the second highest (in this case, the y direction) in step S2.

Thereby, it is possible to recalculate the accurate orientation of each range image and to contribute to accurate alignment of each range image, and further it is possible to obtain the same advantageous effect as that of the first embodiment described above.

### Fourth Embodiment

Next, an image processing device of a fourth embodiment will be described. In the description below of the image processing device of the fourth embodiment, the sections that operate in the same manner as those in each embodiment described above are denoted by the same reference symbols as those used in the description of each embodiment described above and the detailed description thereof will be omitted.

Each embodiment described above acquires a point group and an image at the same time and estimates the posture of the acquired image. Then, the embodiments obtains a relative angle from the posture estimation result and performs alignment on the premise that end points of point groups are coincident with each other. On the other hand, the image processing device of the fourth embodiment further improves the alignment accuracy by using a feature region detected from a color image (RGB image) acquired by the color image acquisition unit 11 for the alignment.

As an example, a normal vehicle includes door mirrors and tires. The door mirrors and the tires are feature regions of the vehicle. Therefore, in the fourth embodiment, many vehicle images are prepared and learned. Further, in the fourth embodiment, when the color image described above is a vehicle, a feature region (a color image feature region) of the vehicle such as a door mirror and a tire is detected by using a learning result. Further, in the fourth embodiment, a range image feature region corresponding to the color image feature region is detected from a range image that is an image of a large number of point groups acquired by the range image acquisition unit 13. In the fourth embodiment, when the alignment of range images is performed, the alignment is performed so that range image feature regions, such as door mirrors and tires, of respective range images overlap with each other.

In the case of each embodiment described above, the end points of the point groups are used for the alignment. However, in the case of the fourth embodiment, feature portions of an object to be aligned are used for the alignment. Thereby, the amount of information used for the alignment increases, so that it is possible to further improve the accuracy of the alignment.

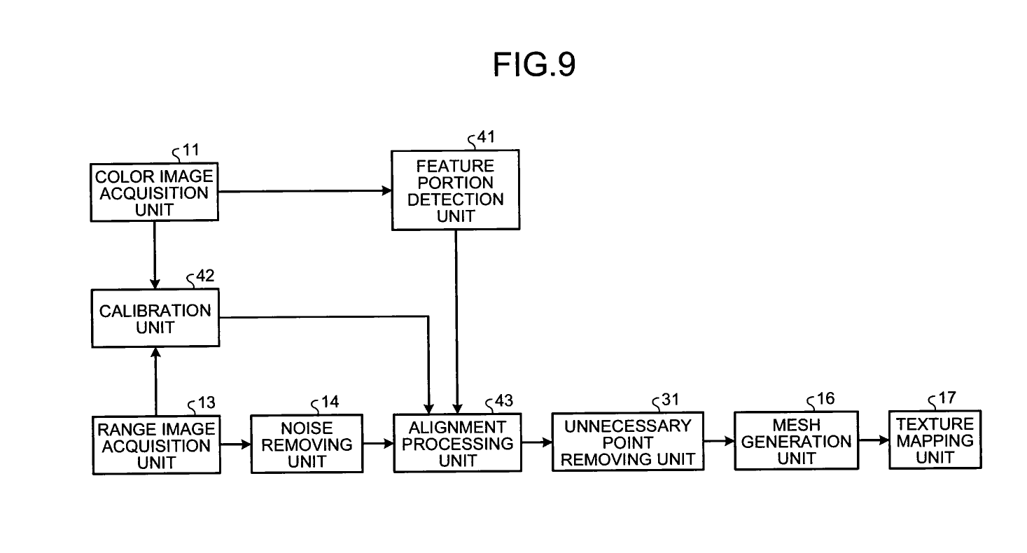

FIG. 9 illustrates a functional block diagram of functions implemented by the CPU 2 executing an image processing program corresponding to the fourth embodiment stored in the HDD 5. When the CPU 2 executes the image processing program corresponding to the fourth embodiment, as illustrated in FIG. 9, the CPU 2 functions as a color image acquisition unit 11, a range image acquisition unit 13, a noise removing unit 14, a mesh generation unit 16, and a texture mapping unit 17. Further, the CPU 2 functions as a feature portion detection unit 41, a calibration unit 42, and an alignment processing unit 43. In this example, the color image acquisition unit 11, the range image acquisition unit 13, the noise removing unit 14, the mesh generation unit 16, the texture mapping unit 17, the feature portion detection unit 41, the calibration unit 42, and the alignment processing unit 43 will be described assuming that these units are implemented by software. However, some or all of these units may be implemented by hardware.

The color image acquisition unit 11 acquires a color image (RGB image) of the observation object. The range image acquisition unit 13 acquires a range image of the observation object. The noise removing unit 14 removes noise such as high-frequency noise from the range image acquired by the range image acquisition unit 13. The mesh generation unit 16 converts each aligned range image into a mesh to generate a three-dimensional model. The texture mapping unit 17 maps a predetermined texture on the three-dimensional model generated by the mesh generation processing. The unnecessary point removing unit 31 forms a range image as an integrated point image by removing points which are unnecessary when two aligned range images are seen as a point image.

When the color image is, for example, a vehicle, the feature portion detection unit 41 detects feature portions (regions) such as tires and door mirrors which are generally included in a vehicle. Then, the feature portion detection unit 41 generates a feature portion labeling image in which a feature portion (region) is labeling-processed. Specifically, the feature portion detection unit 41 performs labeling processing that adds information, such as the same number, to distinguish pixels in the same region from pixels of another region, to the pixels in the same region (in the case of this example, pixels in a feature portion (region)), and generates the feature portion labeling image.

The calibration unit 42 compares the color image from the color image acquisition unit 11 with the range image which is a point group from the range image acquisition unit 13 and thereby detects points on the point group of the range image to which pixels of the color image correspond respectively (calibration of the color image and the range image (point group)). Then, the calibration unit 42 generates calibration information that indicates a correspondence relationship between each pixel of the color image and each point of the range image. The alignment processing unit 43 performs alignment processing of a plurality of range images (point images) acquired by the range image acquisition unit 13 by using the feature portion labeling image and the calibration information.

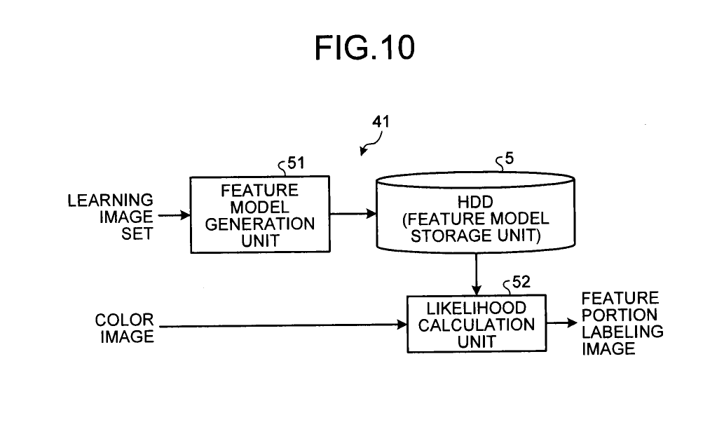

FIG. 10 illustrates a functional block diagram of the feature portion detection unit 41. The feature portion detection unit 41 includes a feature model generation unit 51 and a likelihood calculation unit 52. The feature portion detection unit 41 uses, for example, a technique disclosed in “Wenze Hu, “Learning 3D object templates by hierarchical quantization of geometry and appearance spaces”, CVPR, 2012”. Then, the feature portion detection unit 41 generates a feature portion labeling image in which a feature portion of the observation object is labeling-processed. Either one or both of the feature model generation unit 51 and the likelihood calculation unit 52 may be formed by hardware.

In FIG. 10, the learning image set is a set of images to which image capturing direction information (camera position information) that indicates an image capturing direction of the observation object is added. The feature model generation unit 51 integrates feature portions on the images of the learning image set and generates a feature model in a leaning manner. For example, in the case of an image of a vehicle, door mirrors and tires appear in images of substantially all vehicles. The feature model generation unit 51 integrates such feature portions on the images by considering the camera position and thereby generates the feature model, which is a color image formed by deforming the observation object by the feature portions included in the observation object.

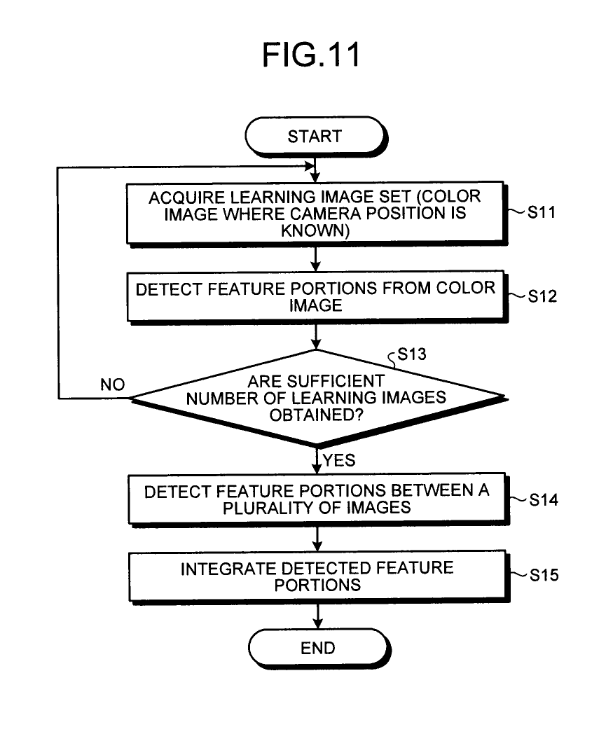

FIG. 11 is a flowchart illustrating a flow in which the feature model generation unit 51 generates (learns) a feature model. In this flowchart, in step S11, the feature model generation unit 51 acquires the learning image set to which the camera position information that indicates the image capturing direction of the observation object is added. Subsequently, in step S12, the feature model generation unit 51 detects feature portions of the observation object from the color image of the acquired learning image set.

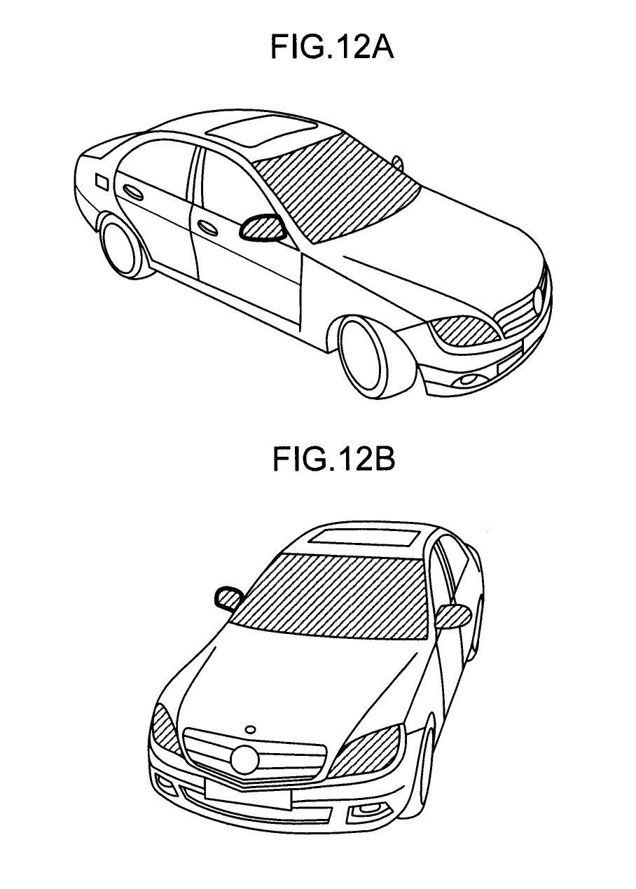

For example, FIG. 12A and FIG. 12B are color images supplied to the feature model generation unit 51 as the learning image set when a vehicle is the observation object. A diagram in FIG. 12A is a diagram obtained by capturing an image of the vehicle from oblique above the left front of the vehicle. On the other hand, a diagram in FIG. 12B is a diagram obtained by capturing an image of the vehicle roughly from above the right front of the vehicle. The camera position information indicating the image capturing direction of the observation object is added to each color image of the vehicle and the color images are supplied to the feature model generation unit 51 as a learning image set.

In step S12, the feature model generation unit 51 detects feature portions of the vehicle such as a windshield, door mirrors, and headlights as indicated by shaded regions in the diagrams in FIG. 12A and FIG. 12B for each learning image set.

Subsequently, in step S13, the feature model generation unit 51 determines whether or not a predetermined number of learning images are obtained. The feature model generation unit 51 repeatedly performs each processing of step S11 to step S13 until the predetermined number of learning images are obtained (step S13: No). When the feature model generation unit 51 determines that the predetermined number of learning images are obtained (step S13: Yes), the feature model generation unit 51 proceeds to step S14.

In step S14, the feature model generation unit 51 detects feature portions between a plurality of learned color images. In step S15, the feature model generation unit 51 integrates the detected feature portions to generate a feature model, stores the feature model in the HDD 5, which is an example of a feature model storage unit, and ends the processing of the flowchart in FIG. 11. Thereby, in the HDD 5, a plurality of feature models, which are a color image obtained by deforming the observation object by the feature portions included in the observation object is stored (accumulated).

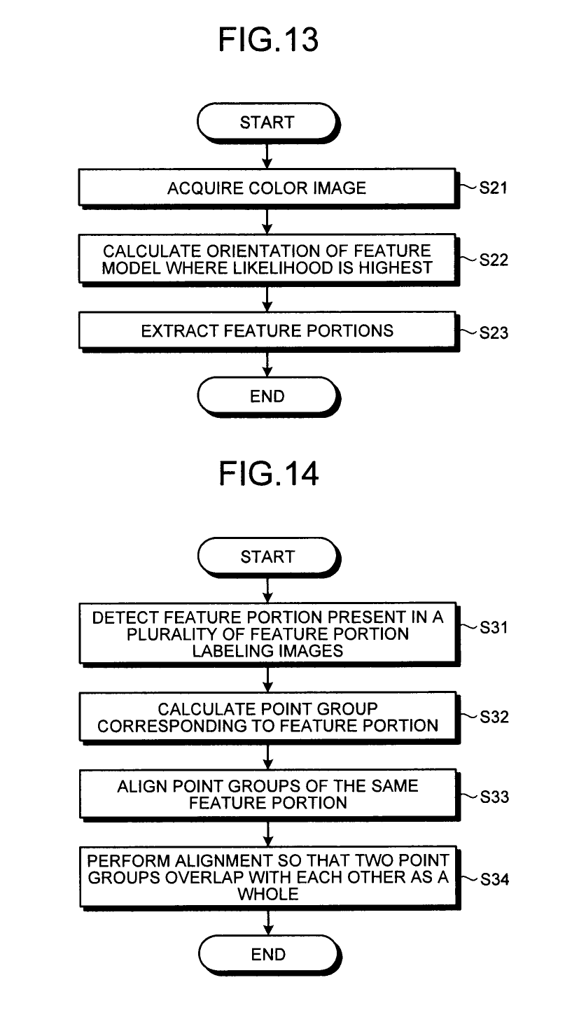

Next, the likelihood calculation unit 52 illustrated in FIG. 10 generates a feature portion labeling image in which a feature portion of the observation object of a color image is labeling-processed by using a feature model. FIG. 13 is a flowchart illustrating a flow of a generation operation of the feature portion labeling image in the likelihood calculation unit 52.

In the flowchart of FIG. 13, in step S21, the likelihood calculation unit 52 acquires a color image from the color image acquisition unit 11 and proceeds to step S22. In step S22, the likelihood calculation unit 52 calculates the orientation of the feature model where the likelihood is the highest by referring to each feature model stored in the HDD 5. Specifically, the likelihood calculation unit 52 detects a feature model of which image capturing direction is the same as that of the observation object of the supplied color image from among the feature models stored in the HDD 5. Then, the likelihood calculation unit 52 calculates the image capturing direction of the detected feature model as the orientation of the feature model where the likelihood is the highest.

Subsequently, in step S23, the likelihood calculation unit 52 generates a feature portion labeling image in which a feature portion of the color image is labeling-processed by using the detected feature model and supplies the feature portion labeling image to the alignment processing unit 43. Thereby, when the observation object of the supplied color image is a vehicle, a feature portion labeling image is generated in which, for example, tires and door mirrors which are feature portions of the vehicle are labeling-processed as illustrated in the diagrams in FIG. 12A and FIG. 12B. Such a feature portion labeling image is supplied to the alignment processing unit 43.

Next, in the case of the image processing device of the fourth embodiment, a feature portion is detected from the color image, a portion in the point group of the range image which corresponds to the feature portion of the color image is detected, and alignment is performed so that feature portions of respective point groups overlap with each other. Therefore, the calibration unit 42 performs calibration processing that associates each pixel of the color image with each point of the point group of the range image which corresponds to each pixel and generates calibration information that indicates each point corresponding to each pixel.

There are various method to perform the calibration processing. As an example, images of a fixed rectangular parallelepiped are captured by an RGB camera and a depth sensor, respectively. Thereby, a color image of the rectangular parallelepiped is obtained from the RGB camera and an image of a point group (a point image) of the rectangular parallelepiped is obtained from the depth sensor. Then, projective transformation processing is performed on the color image or the point image so that the rectangular parallelepiped in the color image and the rectangular parallelepiped in the point image have the same shape. Thereby, it is possible to calculate points on the point image which correspond to each pixel of the color image. The calibration unit 42 performs the calibration processing that associates each pixel of the color image with each point of the range image by performing such projective transformation processing as an example. The calibration unit 42 performs the projective transformation processing on the color image or the point image, so that it is possible to calculate a point group of the range image that corresponds to a feature region of the color image.

The number of pixels of the color image is not necessarily the same as the number of points of the point image. In this case, it is difficult to associate a pixel with a point on a one-to-one basis. In this case, the calibration unit 42 performs the calibration processing so that a pixel and a point closest to each other are associated with each other.

Subsequently, the alignment processing unit 43 performs alignment of point groups of respective range images by using information of feature portions of images (the feature portion labeling images described above) and the calibration information between each pixel of the color image and each point of the range image. For example, when an object is a vehicle, it is assumed that the left door mirror is detected by the feature portion detection unit 41. When the left door mirror is detected in a plurality of range images, point groups in respective range images, which correspond to the left door mirror, overlap with each other. In this way, the alignment processing unit 43 performs alignment of point groups in respective range images by using feature portions.

The flowchart in FIG. 14 illustrates a flow of the alignment processing. The feature portion labeling image is supplied to the alignment processing unit 43 from the feature portion detection unit 41 and a plurality of sets of range images of point groups are supplied to the alignment processing unit 43 from the range image acquisition unit 13. In step S31, the alignment processing unit 43 detects a feature portion present in common in a plurality of feature portion labeling images. For example, when an object is a vehicle, if the left door mirror is present in a plurality of feature portion labeling images, the left door mirror is held.

Subsequently, in step S32, the alignment processing unit 43 calculates a point group corresponding to the feature portion. For example, when the left door mirror is detected from the feature portion labeling images, the alignment processing unit 43 detects point groups on respective range images which correspond to the detected left door mirror.

Subsequently, in step S33, the alignment processing unit 43 aligns the range images so that the detected feature portions of respective range images overlap with each other (the feature portions are overlapped with each other). In the example described above, the alignment processing unit 43 aligns the range images so that the point groups of the left door mirror, which is a feature portion of each range image, overlap with each other. The alignment processing unit 43 detects feature portions as many as possible and aligns the range images so that all the detected feature portions overlap with each other.

Subsequently, in step S34, the alignment processing unit 43 performs alignment so that two point groups overlap with each other as a whole by using, for example, an algorithm of the ICP (Iterative Closest Point) disclosed in Besl, Paul J.; N. D. McKay (1992). “A Method for Registration of 3-D Shapes”. IEEE Trans. on Pattern Analysis and Machine Intelligence (Los Alamitos, Calif., USA: IEEE Computer Society) 14 (2): 239-256 and ends the processing of the flowchart in FIG. 14.

In other words, for each point included in a point group of one range image provided as an input, the alignment processing unit 43 detects a closest point in a point group of another range image by using the ICP algorithm and defines these points as temporary corresponding points. The alignment processing unit 43 estimates rigid body conversion that minimizes the distances between the corresponding points. The alignment processing unit 43 estimates a motion that aligns point groups of two range images by repeating the corresponding point detection and the rigid body conversion estimation.

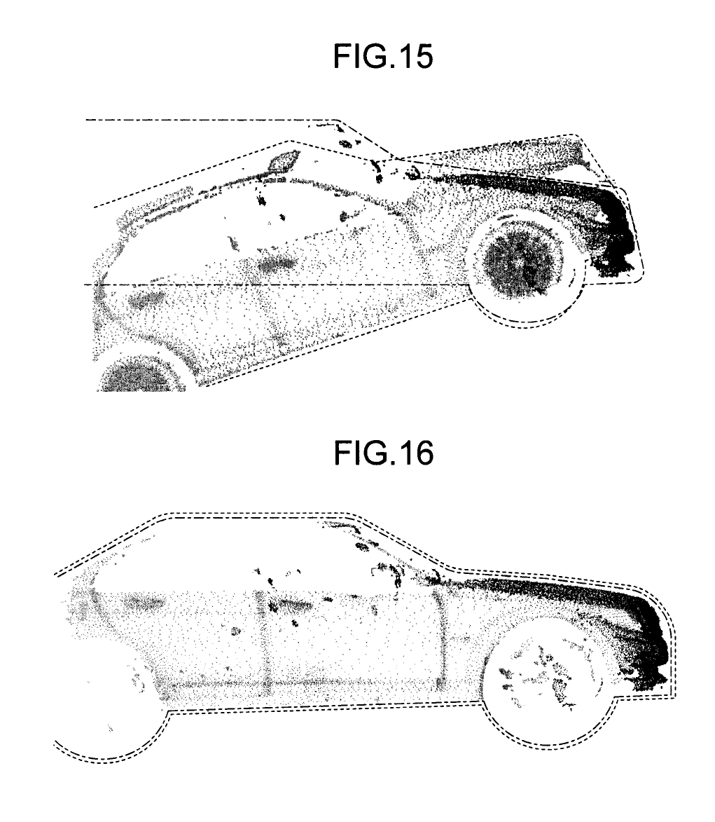

When the alignment is performed on the premise that end points of point groups are coincident with each other, the point groups of respective range images may not overlap with each other as illustrated in FIG. 15. However, as in the case of the image processing device of the fourth embodiment, it is possible to cause the point groups of respective range images to accurately overlap with each other as illustrated in FIG. 16 by performing the alignment using feature portions.

In the image processing device of the fourth embodiment, the noise removing unit 14 illustrated in FIG. 9 removes noise from the range image as described above and supplies the range image to the alignment processing unit 43. Thereby, it is possible to perform accurate alignment after removing a partial distortion and the like generated in the range image, so that it is possible to perform more accurate alignment.

The mesh generation unit 16 and the texture mapping unit 17 illustrated in FIG. 9 generate a three-dimensional model by converting the range images aligned by the alignment processing unit 43 into a meth as one range image. The texture mapping unit 17 attaches a corresponding texture to the generated three-dimensional model and outputs the three-dimensional model.

The unnecessary point removing unit 31 illustrated in FIG. 9 removes points which are unnecessary when two range images aligned by the alignment processing unit 43 are seen as a point image. Thereby, it is possible to form a range image integrated as a point image. The mesh generation unit 16 can perform mesh generation processing without being affected by the unnecessary points.

As obvious from the above description, the image processing device of the fourth embodiment acquires a range image of a point group and a color image captured from the same image capturing direction as that of the range image. The calibration unit 42 performs calibration processing on a range image and a color image and associates each point group of the range image with each pixel of the color image (obtains a correspondence relationship). The feature portion detection unit 41 generates in advance a feature model in which feature portions of the observation object are detected in advance and stores the feature model in the HDD. Further, the feature portion detection unit 41 generates a feature portion labeling image, in which a feature portion of the color image is labeling-processed, by using the feature model detected in advance. The alignment processing unit 43 performs alignment of range images of point groups by using the feature portion labeling image. For example, when an object is a vehicle, it is assumed that the left door mirror is detected by the feature portion detection unit 41. When the left door mirror is detected in a plurality of range images, point groups in respective color images, which correspond to the left door mirror, overlap with each other. The alignment processing unit 43 performs alignment of point groups in respective range images by using such feature portions.

In summary, the image processing device of the fourth embodiment captures a color image and a range image of a point group from the same direction, detects feature portions of the observation object (in the case of a vehicle, tires and door mirrors), and uses information of the feature portions for the alignment of the range image of a point group.

Thereby, even when a portion where point groups of respective range images overlap with each other is small, or even when there is no geometric feature (there is not so much geometric feature), it is possible to perform the alignment accurately. Therefore, it is possible to further improve the degree of accuracy of the alignment.

According to the present invention, there is an effect that a plurality of range images can be accurately aligned.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a range image acquisition unit that acquires at least two range images of an observation object;
a color image acquisition unit that acquires color images of the observation object, which respectively correspond to the range images;
a feature portion detection unit that detects feature portions from the acquired color images;
a calibration unit that performs calibration processing that associates each pixel of the color image with each point of the range image, which corresponds to each pixel, and generates calibration information that indicates each point corresponding to each pixel; and
an alignment processing unit that performs alignment of the range images so that the detected feature portions overlap with each other by using the detected feature portions and the calibration information.

2. The information processing device according to claim 1,
wherein the feature portion detection unit includes
a feature model generation unit that generates a feature model, in which feature portions of a plurality of images to which image capturing direction information indicating an image capturing direction of the observation object is added are detected and integrated, and stores the feature model in a storage unit, and
a likelihood calculation unit that detects a feature model of which image capturing direction is the same as that of the observation object of the color image from the storage unit and generates a feature portion labeling image, in which the feature portion of the color image is labeling-processed, by using the detected feature model, and
the alignment processing unit performs alignment of the range images by using the feature portion indicated by the feature portion labeling image.

3. The information processing device according to claim 1, further comprising:
a noise removing unit that removes noise from the range images and supplies the range images to the alignment processing unit.

4. The information processing device according to claim 1, further comprising:
an unnecessary point removing unit that removes unnecessary points from the aligned range images.

5. The information processing device according to claim 1, further comprising:
a mesh generation unit that performs mesh generation processing on the aligned range images and generates a three-dimensional model.

6. The information processing device according to claim 5, further comprising:
a texture mapping unit that attaches a predetermined texture to the three-dimensional model generated by the mesh generation processing.

7. A non-transitory computer-readable recording medium that therein stores a computer program for causing a computer to execute an information processing method, the method comprising:
a range image acquisition step of acquiring at least two range images of an observation object;
a color image acquisition step of acquiring color images of the observation object, which respectively correspond to the range images;
a feature portion detection step of detecting feature portions from the acquired color images;
a calibration step of performing calibration processing that associates each pixel of the color image with each point of the range image, which corresponds to each pixel, and generating calibration information that indicates each point corresponding to each pixel; and
an alignment processing step of performing alignment of the range images so that the detected feature portions overlap with each other by using the detected feature portions and the calibration information.

8. The non-transitory computer-readable recording medium according to claim 7,
wherein the feature portion detection step includes
a feature model generation step of generating a feature model, in which feature portions of a plurality of images to which image capturing direction information indicating an image capturing direction of the observation object is added are detected and integrated, and storing the feature model in a storage unit, and
a likelihood calculation step of detecting a feature model of which image capturing direction is the same as that of the observation object of the color image from the storage unit and generating a feature portion labeling image, in which the feature portion of the color image is labeling-processed, by using the detected feature model, and
the alignment processing step includes performing alignment of the range images by using the feature portion indicated by the feature portion labeling image.

9. The non-transitory computer-readable recording medium according to claim 7, the method comprising:
a noise removing step of removing noise from the range images and supplying the range images to the alignment processing step.

10. The non-transitory computer-readable recording medium according to claim 7, the method comprising:
an unnecessary point removing step of removing unnecessary points from the aligned range images.

11. The non-transitory computer-readable recording medium according to claim 7, the method comprising:
a mesh generation step of performing mesh generation processing on the aligned range images and generating a three-dimensional model.

12. The non-transitory computer-readable recording medium according to claim 11, the method comprising:
a texture mapping step of attaching a predetermined texture to the three-dimensional model generated by the mesh generation processing.

13. An information processing method comprising:
a range image acquisition step of acquiring at least two range images of an observation object;
a color image acquisition step of acquiring color images of the observation object, which respectively correspond to the range images;
a feature portion detection step of detecting feature portions from the acquired color images;
a calibration step of performing calibration processing that associates each pixel of the color image with each point of the range image, which corresponds to each pixel, and generating calibration information that indicates each point corresponding to each pixel; and
an alignment processing step of performing alignment of the range images so that the detected feature portions overlap with each other by using the detected feature portions and the calibration information.

14. The method according to claim 13, wherein the feature portion detection unit includes
a feature model generation step of generating a feature model, in which feature portions of a plurality of images to which image capturing direction information indicating an image capturing direction of the observation object is added are detected and integrated, and storing the feature model in a storage unit, and
a likelihood calculation step of detecting a feature model of which image capturing direction is the same as that of the observation object of the color image from the storage unit and generating a feature portion labeling image, in which the feature portion of the color image is labeling-processed, by using the detected feature model, and
the alignment processing step includes performing alignment of the range images by using the feature portion indicated by the feature portion labeling image.

15. The non-transitory computer-readable recording medium according to claim 13, the method comprising:
a noise removing step of removing noise from the range images and supplying the range images to the alignment processing step.

16. The non-transitory computer-readable recording medium according to claim 13, the method comprising:
an unnecessary point removing step of removing unnecessary points from the aligned range images.

17. The non-transitory computer-readable recording medium according to claim 13, the method comprising:
a mesh generation step of removing mesh generation processing on the aligned range images and generating a three-dimensional model.

18. The non-transitory computer-readable recording medium according to claim 17, the method comprising:
a texture mapping step of attaching a predetermined texture to the three-dimensional model generated by the mesh generation processing.
